(19) United States
(12) Patent Application Publication
(10) Pub. No.: US 2019/0246598 A1
(43) Pub. Date: Aug. 15, 2019

(54) PET CAGE

(71) Applicant: Weiping Yang, Shenzhen City (CN)

(72) Inventor: Weiping Yang, Shenzhen City (CN)

(21) Appl. No.: 15/968,800

(22) Filed: May 2, 2018

(30) Foreign Application Priority Data
Feb. 9, 2018 (CN) 201810132868.5

(51) Int. Cl. A01K 1/03; A01K 5/00

(52) U.S. Cl. CPC A01K 1/034; A01K 5/00

(57) ABSTRACT

A pet cage including a cage body, wherein a door frame is fixed to the cage body, and the door frame is provided with a feed port therein. The pet cage further comprises a door plate, the door plate is connected to the door frame through a slidable turnover device, which enables the door plate to be turned over and opened after sliding a certain distance relative to the door frame. The feed port is latched with a feeding device. It is more convenient in opening the door plate by using the slidable turnover device; moreover, the feeding device is latched in the feed port by way of clamping, so that the feeding device is installed securely, and it is more convenient in access of the feeding device.

### BACKGROUND AND SUMMARY

The present disclosure relates to the field of pet cage, and more particularly, to a pet cage structure with a door.

In daily busy life of industrialized society, it is expected to stay away from stressful daily work after being off duty, have a good rest, and engage in interested leisure activities. There are a lot of such activities. Some people like to listen to music, some people like to plant flowers, and some people like to keep a pet to cultivate their moods. In busy modern society, pets bring relaxation and happiness to a lot of people, and a bird is one of common pet partners. In order to ensure the safety of such precious family member, the owner of the bird uses a bird cage to keep his pet.

Nowadays feeding is necessary when raising a bird. In order to facilitate feeding, whilst preventing the bird from flying away, a movable door is generally added in the bird cage. Existing door structure mainly has two types: a lifted sliding door directly arranged on the cage; or a vertical hinged door hinged with a side surface of the cage, which door is opened to feed the food into a feeding device. However, the sliding door is locked by its weight, the door additionally needs to be pushed by one hand in the feeding process, and the bird is fed by the other hand, such operation is very inconvenient. Moreover, the vertical hinged door needs to be latched on the cage by an additional lock, otherwise the vertical hinged door is easy to be opened and the bird will fly away, but the addition of a lock not only leads to a complicated structure and results in higher cost, but also it brings trouble to the miser's operation, further, people usually forget to lock the door.

In addition, the structure of the feeding device of the pet cage in the prior art is very simple, the feeding device is simply and directly placed in the bird cage, which not only causes inconvenience in feeding of food and water to the bird, but also causes inconvenience in cleaning of the feeding device, further, the fixation of the feeding device is unreliable, so that such feeding device is easy to be turned over by the bird.

It is desirable to provide a pet cage structure with a door which is more convenient to open.

According to an aspect of the present disclosure, a novel pet cage comprises a cage body, wherein a door frame is fixed to the cage body, and the door frame is provided with a feed port therein. The novel pet cage further comprises a door plate, the door plate is connected to the door frame through a slidable turnover device, which enables the door plate to be turned over and opened after sliding a certain distance relative to the door frame. The feed port is latched with a feeding device.

According to a further aspect of the invention, the slidable turnover device comprises a spindle, sliding grooves and installation holes. The installation holes are arranged in the door frame, the sliding grooves are arranged in the door plate, and the spindle penetrates through the sliding grooves and is coupled with the installation holes. The installation holes are located at a lower part of the door frame, the sliding grooves are located at a lower part of the door plate, the sliding grooves extend along a vertical direction, two ends of each sliding groove are in a semicircle, and a middle part of each sliding groove is in a rectangle, and the width of each sliding groove is slightly larger than the external diameter of the spindle.

According to a further aspect of the invention, a locking piece is further arranged at an upper part of the back of the door plate, a locking groove is arranged at an upper part of the door frame, and the locking piece is separably connected to the locking groove.

According to a further aspect of the invention, the door frame comprises a first base plate, the feed port is located in the middle of the first base plate, the left and right ends of the first base plate are provided with forward turnups, and the installation holes are located at a lower part of the two turnups; the door plate comprises a second base plate, the left and right ends of the second base plate are provided with backwardly bent flanges, and the sliding grooves are each located at a lower pert of the two flanges; the top end of the turnup is provided with a bevel edge, and the bevel edge gradually slopes down from front to back; two locking blocks are provided, and which are located at a upper part of the flanges; the first base plate is fixedly connected to the cage body with the back of the first base plate, a gap is provided between the upper end of the first base plate and the cage body, and the gap forms the locking groove.

According to a further aspect of the invention, the spindle is provided with a clamping point at one end thereof, while the spindle is provided with a polish rod section at the other end, the spindle is provided with a clamping section at the middle part, the door frame is provided with an installation groove, and the clamping section is latched with the installation groove.

According to a further aspect of the invention, the feed port comprises a lower edge, the feeding device comprises a clamping plate and a feeding dish, the clamping plate is fixed at the back end of the feeding dish, a clamping groove is formed between the clamping plate and the feeding dish. Both the width and the height of the feeding dish are smaller than the width and the height of the feed port, and the clamping groove is latched in the lower edge.

According to a further aspect of the invention, the width of the clamping plate is larger than the width of the feed port, the door frame is further provided with limiting seats, the bottom surfaces of the limiting seat abut against the upper end surface of the clamping plate. Two limiting seats are provided, and the two limiting seats are respectively arranged at the left and right sides of the feed port.

According to a further aspect of the invention, both the left and right ends of the feed port are provided with a baffle, the baffle slopes from the two ends to the middle of the feed port; and the back end of the baffle abuts with the external end surface of the feeding dish.

According to a further aspect of the invention, the clamping plate comprises a connecting part and a clamping part, the connecting part is surrounded by the clamping part, the connecting part is lower than the clamping part, the connecting part is fixedly connected to the back end surface of the feeding dish, the clamping groove is formed between the lower end of the clamping part and the back end surface of the feeding dish; and the left and right ends of the clamping part are butted with the surface of the door frame.

According to a further aspect of the invention, the front surface of the door plate is provided with a grip; and the clamping plate is further provided with a lifting handle.

The device according to the present disclosure has beneficial effects in that: it's more convenient in opening the door plate by using the slidable turnover device; moreover, the feeding device is latched in the feed port by way of clamping, so that the feeding device is installed securely, and it's more convenient in access of the feeding device.

### BRIEF DESCRIPTION OF THE DRAWINGS

In order to explain the technical solution in the embodiments more clearly, the drawings incorporated with the embodiments will be simply described hereinafter. Apparently, the described drawings are only partial embodiments of the present disclosure instead of all the embodiments, and those skilled in the art can make other design schemes and drawings according to these drawings without going through any creative work.

FIG. 1 is a schematic diagram of the overall structure of the present disclosure;

FIG. 2 is an exploded installation diagram of a door plate and a door frame of the present disclosure; and

FIG. 3 is an exploded installation diagram of the door frame and a feeding device of the present disclosure.

### DETAILED DESCRIPTION

The conception, specific structure and technical effects of the device according to the present disclosure are clearly and completely described with reference to the embodiments and the drawings, so as to fully understand the objects, features and effects of the device according to the present disclosure. Apparently, the described embodiments are only partial embodiments of the present disclosure instead of all the embodiments. Based on the embodiments of the present disclosure, other embodiments made by those skilled in the art without going through any creative work shall all fall within the protection scope of the present invention. In addition, all coupling/connection relations referred herein are intended to indicate advantageous connection structure realized by adding or reducing a connecting accessory according to a specific embodiment, instead of merely indicating a direct connection of components. All technical features in the present disclosure can be combined with each other in case of no conflicts there between.

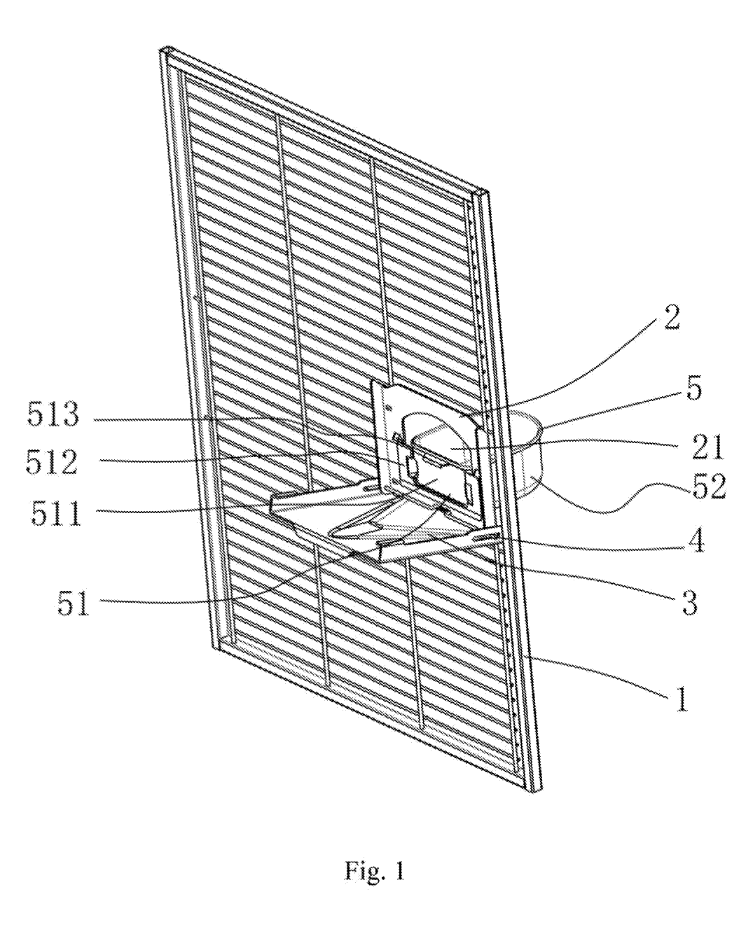

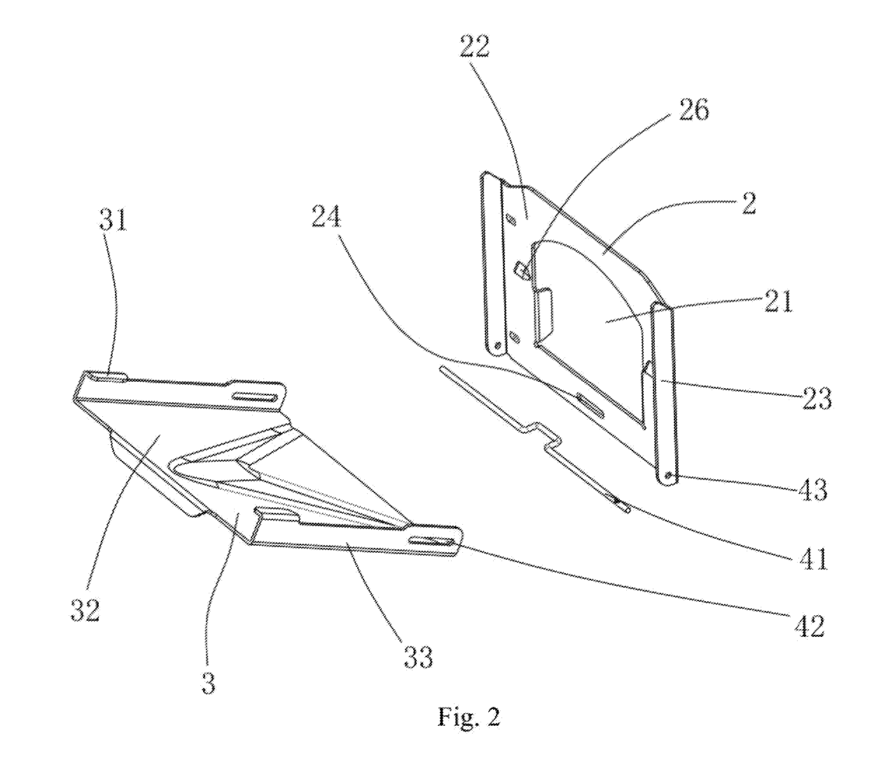

With reference to FIG. 1 to FIG. 2, a novel pet cage comprises a cage body 1, wherein a door frame 2 is fixed to the cage body 1, and the door frame 2 is provided with a feed port 21 therein. The novel pet cage further comprises a door plate 3, the door plate 3 is connected to the door frame 2 through a slidable turnover device 4, which enables the door plate 3 to be turned over and opened after sliding a certain distance relative to the door frame 2. The feed port 21 is latched with a feeding device 5. When the door plate needs to be opened, it firstly slides a certain distance along a linear direction, so that the door plate is staggered with the door frame by a certain distance, and then the door plate is turned over to enable the raiser to put the foods in through the feed port. Moreover, the sliding direction can be vertically upward, and a self-locking can be achieved by the weight of the door plate when the door plate is closed. In addition to the vertically upward sliding direction, the sliding direction can also be horizontally forward, for example, the door plate firstly slides a certain distance forwardly, and then the door plate is turned over and opened. However, the way of opening by sliding vertically upward has an advantage that after the door plate is opened, the edge of the door plate can be butted with the end surface of the door frame, so that the door plate can only be turned over to 90°, and after the door plate is turned over at 90°, the plate surface of the door plate is basically parallel with level, which can be used as a supporting platform to facilitate the placement of feed dish and other articles on the door plate. Of course, in case of overturn opening after horizontal sliding, the placement of articles may be also achieved by adding a platform at a side surface of the door plate, but this structure can be bloated and occupies the space. In order to facilitate the storage, the platform may need to be hinged with the door plate, so that the structure is complicated, and the production cost is high.

Further, as a preferred embodiment, the slidable turnover device 4 comprises a spindle 41, sliding grooves 42 and installation holes 43. The installation holes 43 are arranged in the door frame 2, the sliding grooves 42 are arranged in the door plate 3, and the spindle 41 penetrates through the sliding grooves 42 and is coupled with the installation holes 43. The installation holes 43 are located at a lower part of the door frame 2, the sliding grooves 42 are located at a lower part of the door plate 3, the sliding grooves 42 extend along a vertical direction, two ends of each sliding groove 42 are in a semicircle, and a middle part of each sliding groove is in a rectangle, and the width of each sliding groove is slightly larger than the external diameter of the spindle 41. During installation, the sliding groove is aligned with the installation hole, and then the spindle penetrates the sliding grooves and the installation holes, so as to complete the assembly of the door plate and the door frame. The structure is simple and convenient, and the sliding of the door plate is achieved by sliding the spindle in the sliding groove. Preferably, the door plate is slided in vertical direction and turned over, accordingly, the installation holes are located at a lower part of the door frame, and the sliding grooves extend along the vertical direction. Of course, if the door plate is opened by horizontal sliding and overturning, the matched installation holes are installed on the left of the door frame, and the sliding grooves extend along a horizontal direction.

Further, as a preferred embodiment, a locking piece 31 is further arranged at an upper part of the back of the door plate 3, a locking groove is arranged at an upper part of the door frame 2, and the locking piece 31 is separably connected to the locking groove. The locking of the door frame and the door plate of the present disclosure is also very simple, through providing the locking piece at the back of the door plate and then arranging the locking groove on the door frame, when the door plate slides upwardly, the locking piece is separated from the locking groove, so that the door plate can be turned over, and when the door plate is closed, since the locking piece falls into the locking groove under the effect of gravity, the door plate cannot rotate relative to the door frame. Moreover, the structures of the locking piece and the locking groove can be various only if locking piece and the locking groove can be separated in sliding of the door plate.

Further, as a preferred embodiment, the door frame 2 comprises a first base plate 22, the feed port 21 is located in the middle of the first base plate 22, the left and right ends of the first base plate 22 are provided with forward turnups 23, and the installation holes 43 are located at a lower part of the two turnups 23; the door plate 3 comprises a second base plate 32, the left and right ends of the second base plate 32 are provided with backwardly bent flanges 33, and the sliding grooves 42 are each located at a lower part of the two flanges 33; two locking blocks 31 are provided, and which are located at an upper part of the flanges 33; the first base plate 22 is fixedly connected to the cage body 1 with the back of the first base plate 22, a gap is provided between the upper end of the first base plate 22 and the cage body 1, and the gap forms the locking groove. The door frame and the door plate are both made of sheet metal stamping parts. The turnup, the feed port, the flange of the door plate, the sliding groove and other structures are directly formed by a single one stamping in the production, so as to increase the production efficiency. Similarly, the locking piece is also stamped once into a shape from the sheet metal, which increases the production efficiency. Moreover, the locking pieces are located on the two flanges, so that the locking of the door plate can be more reliable; and a gap is provided between the first base plate and the cage body, the gap can contain the locking piece. The locking piece can be close to the cage body during closing and in a closed state of the door plate, so that the structure is more compact.

Further, as a preferred embodiment, the top end of the turnup 23 is provided with a bevel edge, and the bevel edge gradually slopes down from front to back. The door plate can be more convenient to be closed through the bevel edge, the bevel edge will lead the door plate to automatically slide downwardly when the locking piece is placed on the bevel edge, and the operation is simple.

Further, as a preferred embodiment, the spindle 41 is provided with a clamping point at one end thereof, while the spindle 41 is provided with a polish rod section at the other end, the spindle 41 is provided with a clamping section at the middle part, the door frame 2 is provided with an installation groove 24, and the clamping section is latched with the installation groove 24. Since the clamping point at one end of the spindle can prevent the spindle from completely passing through the installation hole, during installation, the polish rod end of the spindle is firstly inserted into the installation hole and the sliding groove at either side, after penetration of the polish rod end into the installation hole and the sliding groove at one side, the end of the spindle 41 with the clamping point is then aligned with the installation hole and the sliding groove at the other side, and the installation hole and the sliding groove at the other side are penetrated in a reverse direction to enable the clamping point on the spindle to be blocked by the installation hole. At the moment, the direction of the clamping section of the spindle is adjusted, so as to match with the installation groove, by this way the installation of the door plate, the spindle and the door frame is achieved. The whole installation process needs no assistance of any tools, which increases the operability and efficiency of the assembly and disassembly.

All the structures above are all on the basis that the sliding groove is installed on the door plate, but the sliding groove and the installation position can be interchanged actually. That is, alternatively, the installation holes 43 can be arranged in the door plate 3, the sliding grooves 42 can be arranged on the door frame, and the spindle 41 penetrates through the sliding grooves 42 and the installation holes 43 for coupling. In case of the sliding groove being installed on the door frame, the sliding groove will be in a shape like “7”, because after the spindle moves upwardly it needs to move a certain distance horizontally, so that the sliding groove can offer support to the spindle as it reach the top of the sliding groove, so as to enable the overturning of the door plate.

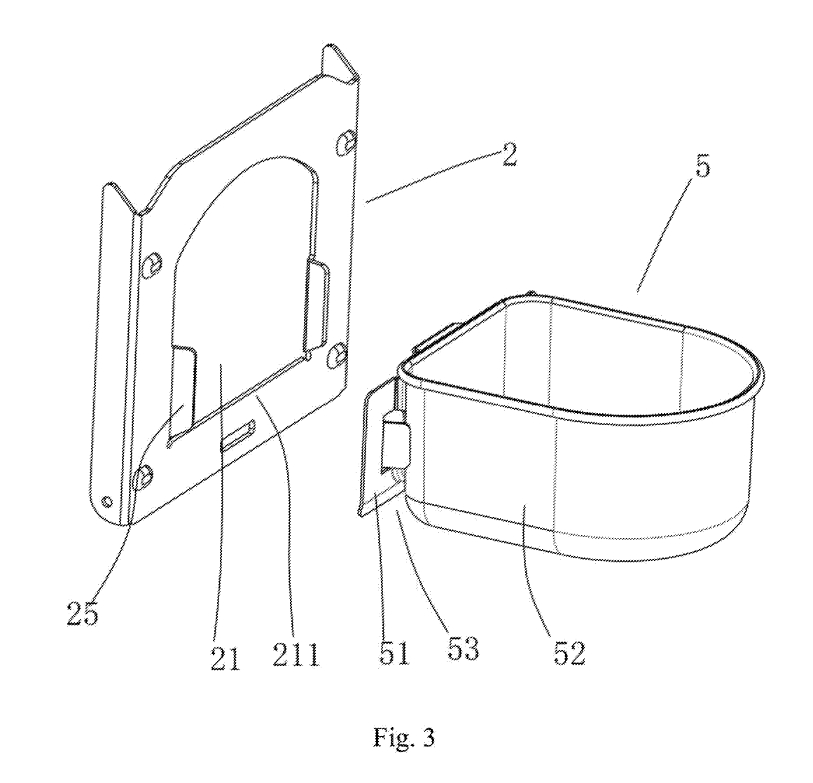

With reference to FIG. 1 and FIG. 3, and further, as a preferred embodiment, the feed port 21 comprises a lower edge 211, the feeding device 5 comprises a clamping plate 51 and a feeding dish 52, the clamping plate 51 is fixed at the back end of the feeding dish 52, a clamping groove 53 is formed between the clamping plate 51 and the feeding dish 52. Both the width and the height of the feeding dish 52 are smaller than the width and the height of the feed port 21, and the clamping groove 53 is latched in the lower edge 211. The installation of the feed device is achieved by a clamping connection of the clamping groove with the lower edge, and by the clamping plate surface being abutted against the door frame surface, so as to achieve a firm installation of the feed device. The feed device stretches into the cage body from the feed port, then the clamping groove is latched in the lower edge of the feed port, the thickness of the lower edge is the thickness of the door plate, and the thickness is slightly smaller than the width of the clamping groove. Therefore, the feed device can be detachably connected to the door frame, and since the door frame can be fixed in the cage body, such as by welding, the feed device can be reliably connected to the cage body. Moreover, the width of the clamping plate can be larger than the width of the feed port, so as to prevent the feed device from falling into the cage body.

Further, as a preferred embodiment, the width of the clamping plate 51 is larger than the width of the feed port 21, the door frame 2 is further provided with limiting seats 26, the bottom surfaces of the limiting seat 26 abut against the upper end surface of the clamping plate 51. Two limiting seats 26 are provided, and the two limiting seats 26 are respectively arranged at the left and right sides of the feed port 21. By adding two limiting seats, the upper end surface of the clamping plate abuts against the limiting seats, so that the feed device can be more firmly installed. Moreover, in order to facilitate the installation, the bottom surface of the limiting seat is an oblique plane, and the clamping plate can enable the feed dish to pass through the feed port more conveniently along the oblique plane in installation.

Further, as a preferred embodiment, both the left and right ends of the feed port 21 are provided with a baffle 25, the baffle 25 slopes from the two ends to the middle of the feed port 21; and the back end of the baffle 25 abuts with the external end surface of the feeding dish 52. The baffle is installed at the bottom of the feed port, and the baffle slopes to the middle, thus the baffle can firstly functions as guiding. Additionally, the back end of the baffle abuts with the external end surface of the feed dish, thus the claw of a bird can be prevented from being accidently stuck in the gap between the feed dish and the first base plate, where a bird may injured may accidently.

Further, as a preferred embodiment, the clamping plate 51 comprises a connecting part 511 and a clamping part 512, the connecting part 511 is surrounded by the clamping part 512, the connecting part 511 is lower than the clamping part 512, the connecting part 511 is fixedly connected to the back end surface of the feeding dish 52, the clamping groove 53 is formed between the lower end of the clamping part 512 and the back end surface of the feeding dish 52; and the left and right ends of the clamping part 512 are butted with the surface of the door frame 2. As mentioned above, the door frame and the door plate are both stamped into shape by the sheet metal, and the clamping plate can also be stamped into shape by the sheet metal, so as to increase the production efficiency. The connecting part may be in a rectangle, which increases the contact area of the connecting part and the feed dish, so that the connection of the connecting part and the feed dish is more reliable, and the clamping part is higher than the connecting part, which enables the installation and the connection of the first base plate and the feed device to be more convenient.

Further, as a preferred embodiment, the lower end of the clamping part 512 slopes forwardly, which makes it smoother for the clamping groove to enter the lower edge.

Further, as a preferred embodiment, the front surface of the door plate 3 may be provided with a grip or handle; and the clamping plate 51 may be further provided with a lifting handle 513. The operation to the door plate is convenient through the grip; and the carrying of the feed device is convenient through the lifting handle.

Further, as a preferred embodiment, the feed dish 52 comprises a front part and a back part, the vertical projection plane of the front part is in a rectangle, the vertical projection plane of the back part is in a semicircle, and the top end of the feed dish 52 is provided with a turnup. Since the back part is in a semicircle, it is easy for the feed dish to be placed in and taken out; the turnup of the top end can increase the strength of the feed dish, and prevent the top end of the feed dish from having a sharp edge, which may accidentally injure the bird while feeding.

Further, as a preferred embodiment, the back of the door plate is provided with a convex piece, which abuts with the front end of the clamping plate 51. When the door plate is closed, the convex piece pushes the clamping plate, so that the installation of the clamping plate and feed device is securer and more reliable.

The preferred embodiments of the present disclosure are described in detail in the contents above, but the present disclosure is not limited to the embodiments, those skilled in the art can further make various equivalent modifications and replacements without departing from the nature of the present disclosure, and these equivalent modifications and replacements shall all fall within the scope limited by the claims of the application.

What is claimed is:

1. A pet cage, comprising:
a cage body;
a feeding device;
a door frame fixed to the cage body, wherein the door frame is provided with a feed port therein, the feed port is latched with the feeding device;
a door plate connected to the door frame through a slidable turnover device;
a slidable turnover device which enables the door plate to be turned over and opened after sliding a certain distance relative to the door frame.

2. The pet cage according to claim 1, wherein the slidable turnover device comprises:
installation holes arranged in the door frame, and located at a lower part of the door frame;
a spindle penetrates through sliding grooves and is coupled with the installation holes;
sliding grooves arranged in the door plate, and located at a lower part of the door plate, wherein the sliding grooves extend along a vertical direction, two ends of each sliding groove are in a semicircle, and a middle part of each sliding groove is in a rectangle, and the width of each sliding groove is slightly larger than the external diameter of the spindle.

3. The pet cage according to claim 2, wherein:
a locking piece is arranged at an upper part of the back of the door plate;
a locking groove is arranged at an upper part of the door frame; and
the locking piece is separably connected to the locking groove.

4. The pet cage according to claim 3, wherein:
the door frame comprises a first base plate, the feed port is located in the middle of the first base plate,
the left and right ends of the first base plate are provided with forward turnups, and the installation holes are located at a lower part of the two turnups; the top end of each turnup is provided with a bevel edge, and the bevel edge gradually slopes down from front to back; the first base plate is fixedly connected to the cage body with the back of the first base plate, a gap is provided between the upper end of the first base plate and the cage body, and the gap forms the locking groove;
the door plate comprises a second base plate, the left and right ends of the second base plate are provided with backwardly bent flanges, and the sliding grooves are each located at a lower part of the two flanges; two locking blocks are provided, and which are located at a upper part of the flanges.

5. The pet cage according to claim 2, wherein
the door frame is provided with:
an installation groove;
the spindle is provided with:
a clamping point at one end thereof,
a polish rod section at the other end thereof,
a clamping section at the middle part, latched with the installation groove.

6. The pet cage according to claim 1, wherein
the feed port comprises a lower edge;
the feeding device comprises a clamping plate and a feeding dish, the clamping plate is fixed at the back end of the feeding dish, a clamping groove is formed between the clamping plate and the feeding dish, both the width and the height of the feeding dish are smaller than the width and the height of the feed port, and
the clamping groove is latched in the lower edge.

7. The pet cage according to claim 6, wherein the width of the clamping plate is larger than the width of the feed port, the door frame is further provided with limiting seats, the bottom surfaces of the limiting seat abut against the upper end surface of the clamping plate; two limiting seats are provided, and the two limiting seats are respectively arranged at the left and right sides of the feed port.

8. The pet cage according to claim 7, wherein both the left and right ends of the feed port are provided with a baffle, the baffle slopes from the two ends to the middle of the feed port; and the back end of the baffle abuts with the external end surface of the feeding dish.

9. The pet cage according to claim 6, wherein the clamping plate comprises a connecting part and a clamping part, the connecting part is surrounded by the clamping part, the connecting part is lower than the clamping part, the connecting part is fixedly connected to the back end surface of the feeding dish, the clamping groove is formed between the lower end of the clamping part and the back end surface of the feeding dish; and the left and right ends of the clamping part are butted with the surface of the door frame.

10. The pet cage according to claim 1, wherein the front surface of the door plate is provided with a grip; and the clamping plate is further provided with a lifting handle.
